(19) United States
(12) Patent Application Publication
(10) Pub. No.: US 2007/0003252 A1
(43) Pub. Date: Jan. 4, 2007

(54) Projecting device capable of synchronously encoding images and sounds into an audio/video synchronous play file

(75) Inventors: Chung-Song Kuo, Jhonghe City (TW); Po-Chih Hung, Jhonghe City (TW); Jiun-Shin Wu, Jhonghe City (TW); Yung-Hsi Wu, Jhonghe City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AverMedia Technologies Inc.

(21) Appl. No.: 11/211,186

(22) Filed: Aug. 25, 2005

(30) Foreign Application Priority Data
Jul. 4, 2005 (TW) 94122614

(51) Int. Cl. H04N 7/00

(52) U.S. Cl. 386/96

(57) ABSTRACT

A projecting device capable of synchronously encoding images and sounds into an AV play file includes a receiving unit, a first processing unit, a projecting unit, a sound-recording unit, a second processing unit and an AV encoding unit. The receiving unit receives and outputs a first video signal. The first processing unit receives the first video signal to output a second video signal. The projecting unit receives the second video signal and projects a corresponding image onto a wall. The sound-recording unit records sounds of a user as explaining the image and outputs a first audio signal accordingly. The second processing unit receives the first audio signal to output a second audio signal. The AV encoding unit receives and synchronously encodes the second video signal and the second audio signal into an AV synchronous play file.

This application claims the benefit of Taiwan application Serial No. 94122614, filed Jul. 4, 2005, the subject matter of which is incorporated herein by reference.

### BACKGROUND OF THE INVENTION

1. Field of the Invention

The invention relates in general to a projecting device, and more particularly to a projecting device capable of synchronously encoding images and sounds into an audio/video (AV) synchronous play file.

2. Description of the Related Art

Along with scientific development, optical projecting systems are invented and widely applied to various fields, such as entertainment facilities and equipments for business affairs, image projecting systems utilized in a large-scaled conference speech for magnifying projection films, or commercial large-scaled rear-projection TVs. The present projecting devices include an image output projecting device, an object projecting device, and a film projecting device. The image output projecting device can project a computer' pictures onto a wall as electrically coupled to the computer while the object projecting device can project a clear and magnified image of any object, such as documents or substances, placed within its image capturing range, onto the wall. As for the film projecting device, when the user places a projection film on its projecting flatbed, the film projecting device can magnify the light passing through the projection film and then project an image corresponding to the content of projection film onto the wall in an optical way. Therefore, the user can write directly on the projection film and the audience can observe the lively process that the user writes from the image projected onto the wall.

When the presenter gives a brief by using the above-mentioned projecting device, the audience are usually given materials relevant to the brief, therefore, the audience can observe the image projected by the projecting device, while listening to presenter's explanation about the brief and taking notes in the given materials. After finishing the brief, the presenter may share electronic files of brief materials with the audience generously. However, after a period of time when these persons pick up the brief materials or review their electronic files, they may forget why they have taken the notes in the brief materials, or may not understand partial contents of the brief materials, or feel even confused due to inconsistency of the brief materials from beginning to end.

Although the audience can use a video camera to record images and sounds in process of presentation, however, the video camera usually outputs very large AV files and is thus not convenient for the audience to carry for review.

Even if the audience records sounds of the presenter into an audio file by a recording pen, the audience may also feel confused about which part of the brief materials corresponds to a specific portion of audio files as they review the brief materials in the future.

### SUMMARY OF THE INVENTION

It is therefore an object of the invention to provide a projecting device capable of synchronously encoding images and sounds into an AV synchronous play file. By encoding images and sounds synchronously as an AV synchronous play file In the process when the presenter gives a brief, the audience can read the image content while listening to the recorded sound corresponding to the image as they open the AV synchronous play file in the future. Therefore, the audience can quickly regain the lively feeling as attending the conference before and achieve the purpose of reviewing and revising the brief materials. It can be prevented not only the unfamiliar feeling occurred as reviewing the brief materials in the future but also the confusing issue due to inconsistency of the brief materials from beginning to end in the future review, thereby greatly increasing practicality of the projecting device.

The invention achieves the above-identified object by providing a projecting device capable of synchronously encoding images and sounds into an AV play file, including a receiving unit, a first processing unit, a projecting unit, a sound-recording unit, a second processing unit and an AV encoding unit. The receiving unit is for receiving and outputting a first video signal. The first processing unit, electrically coupled to the receiving unit, is for receiving and processing the first video signal and outputting a second video signal accordingly. The projecting unit, electrically coupled to the first processing unit, is for receiving the second video signal and projecting an image corresponding to the second video signal onto a wall. The sound-recording unit is for recording sounds of a user as explaining the image corresponding to the second video signal and outputting a first audio signal accordingly. The second processing unit, electrically coupled to the sound-recording unit, is for receiving and processing the first audio signal and outputting a second audio signal accordingly. The AV encoding unit, electrically coupled to the first processing unit and the second processing unit, is for receiving and synchronously encoding the second video signal and the second audio signal and outputting an AV synchronous play file accordingly.

The invention achieves the above-identified object by providing a projecting device capable of synchronously encoding images and sounds into an AV play file, including an image capturing unit, a first processing unit, a sound-recording unit, a second processing unit, and an AV encoding unit. The image capturing unit is for capturing an image of an object and outputting a first video signal accordingly. The first processing unit, electrically coupled to the image capturing unit and an external projecting device, is for receiving and processing the first video signal and outputting at least a second video signal to the external projecting device for projecting onto a wall accordingly The sound-recording unit is for recording sounds of a user as explaining the image corresponding to the second video signal and outputting a first audio signal accordingly. The second processing unit, electrically coupled to the sound-recording unit, is for receiving and processing the first audio signal and outputting a second audio signal accordingly. The AV encoding unit, electrically coupled to the first processing unit and the second processing unit, is for receiving and synchronously encoding the second video signal and the second audio signal and outputting an AV synchronous play file accordingly.

The invention achieves the above-identified object by providing a projecting device capable of synchronously encoding images and sounds into an AV play file, including a light emitting unit, a projecting unit, an image capturing unit, a first processing unit, a sound-recording unit, a second processing unit, and an AV encoding unit. The light emitting unit is for providing a beam of light to a projection film. The projecting unit is for magnifying and projecting the light passing through the projection film onto a wall to display an image corresponding to content of the projection film. The image capturing unit is for capturing the image and outputting a first video signal accordingly. The first processing unit, electrically coupled to the image capturing unit, is for receiving and processing the first video signal and outputting a second video signal accordingly. The sound-recording unit is for recording sounds of a user as explaining an image corresponding to the second video signal and outputting a first audio signal accordingly. The second processing unit, electrically coupled to the sound-recording unit, is for receiving and processing the first audio signal and outputting a second audio signal accordingly. The AV encoding unit, electrically coupled to the first processing unit and the second processing unit, is for receiving and synchronously encoding the second video signal and the second audio signal and outputting an AV synchronous play file accordingly.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A shows a block diagram of a projecting device capable of synchronously encoding images and sounds into an AV synchronous play file according to the first embodiment of the invention.

FIG. 1B shows a solid view of an electronic device equipped with a projecting device capable of synchronously encoding images and sounds into an AV synchronous play file according to the first embodiment of the invention.

FIG. 2A shows a block diagram of a projecting device capable of synchronously encoding images and sounds into an AV synchronous play file, an external projecting device, and a recoriding medium according to the second embodiment of the invention.

FIG. 2B shows a solid view of a projecting device capable of synchronously encoding images and sounds into an AV synchronous play file, an object, and an external projecting device according to the second embodiment of the invention.

FIG. 3A shows a block diagram of a projecting device capable of synchronously encoding images and sounds into an AV synchronous play file according to the third embodiment of the invention.

FIG. 3B shows a solid view of a projecting device capable of synchronously encoding images and sounds into an AV synchronous play file, and a projection film according to the third embodiment of the invention.

### DETAILED DESCRIPTION OF THE INVENTION

### Embodiment One

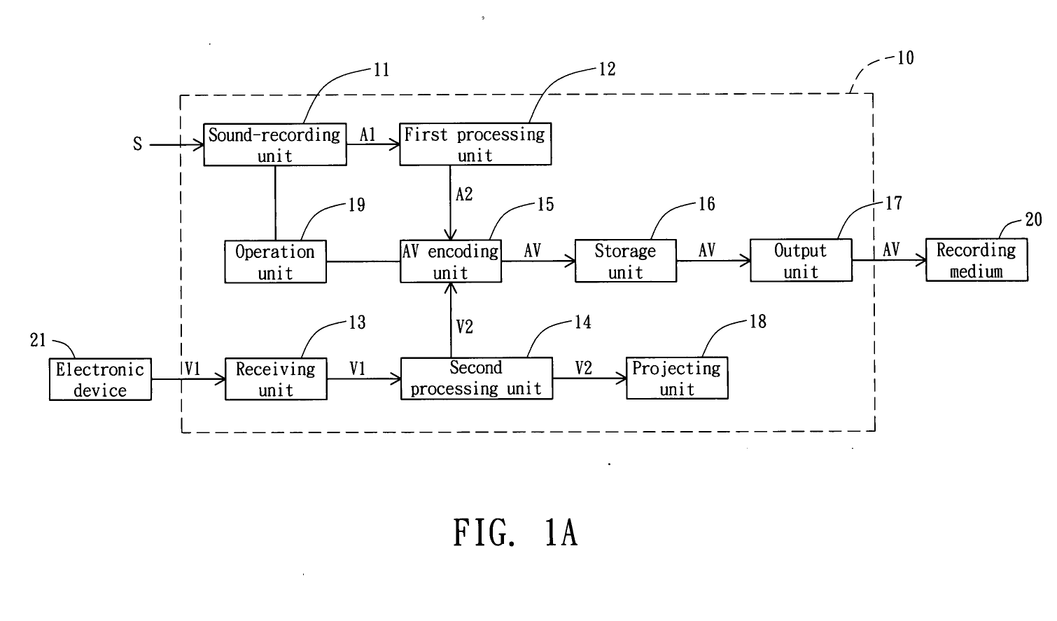

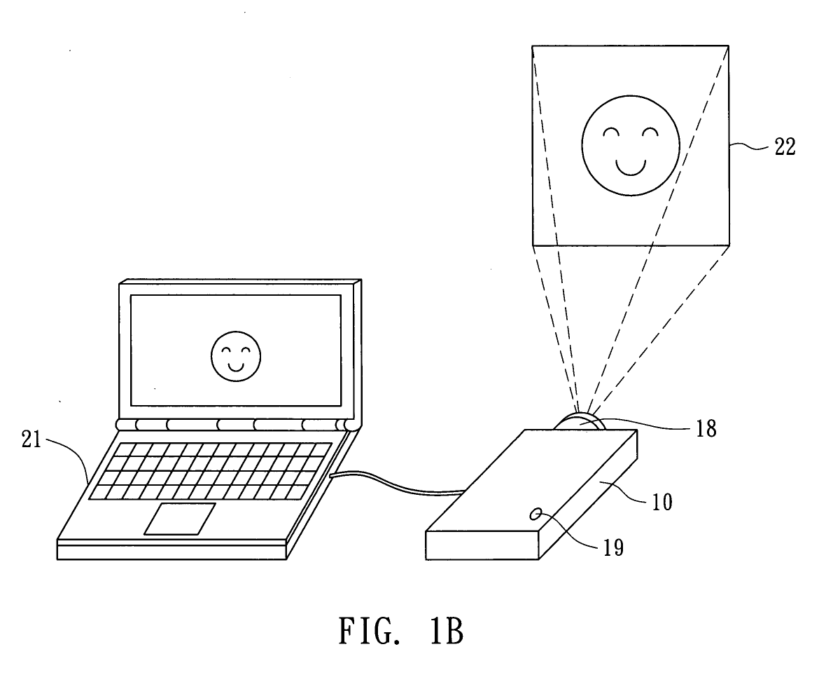

FIG. 1A shows a block diagram of a projecting device capable of synchronously encoding images and sounds into an AV synchronous play file according to the first embodiment of the invention while FIG. 1B shows a solid view of an electronic device equipped with a projecting device capable of synchronously encoding images and sounds into an AV synchronous play file according to the first embodiment of the invention. Referring to FIGS. 1A and 1B at the same time, the projecting device 10 includes a receiving unit 13, a first processing unit 12, a projecting unit 18, a sound-recording unit 11, a second processing unit 14, and an AV encoding unit 15. The receiving unit 13, electrically coupled to an electronic device 21, is for receiving a first video signal V1 from the electronic device 21. The electronic device 21 can be a computer, such as a desktop computer, a notebook computer, a laptop computer, and a handheld computer, or a portable electronic device, such as a mobile phone and a personal digital assistant. In the embodiment, a notebook computer is taken as an example for the electronic device 21.

The first processing unit 12, electrically coupled to the receiving unit 13, is for receiving and processing the first video signal V1, and outputting a second video signal V2. For example, the first processing unit 12 performs chroma and brightness strengthening processing on the first video signal V1 to output the second video signal V2 with a better image quality. The projecting unit 18, electrically coupled to the first processing unit 14, is for receiving the second video signal V2 and projecting the image 22 corresponding to the second video signal V2 onto a wall.

The sound-recording unit 11 records the sound S of a user as explaining the image corresponding to the second video signal V2 and outputs a first audio signal A1 accordingly. The second processing unit 12, electrically coupled to the sound-recording unit 11, is for receiving and processing the first audio signal A1 to output a second audio signal A2. For example, the second processing unit 12 can reduce the first audio signal A1 in a DC offset way and then filters noises and background voices off the first audio signal A1 to make the user's sound stand out. The AV encoding unit 15, electrically coupled to the first processing unit 12 and the second processing unit 14, is for receiving and synchronously encoding the second video signal V2 and the second audio signal A2 into a AV synchronous play file AV according to a timing process.

In the embodiment, the projecting device 10 further includes a storage unit 16, electrically coupled to the AV encoding unit 15, for receiving and storing the AV synchronous play file AV. Moreover, the projecting device further includes an output unit 17, electrically coupled to the storage unit 16, for outputting the AV synchronous play file AV to a recording media 20. Besides, the projecting device includes an operation unit, disposed on the housing of the projecting device 10, and electrically coupled to the sound-recording unit 11 and the AV encoding unit 15. When the user presses the operation unit 19, the projecting device 10 actuates the sound-recording unit 11 and the AV encoding unit 15. When the user presses the operation unit 19 once again, the projecting device 10 stops operation of the sound-recording unit 11 and the AV encoding unit 15. The user can starts and stop the recording and AV encoding operation of the projecting device 11 by hand through the operation unit 19.

In addition, the projecting device 11 can start the sound-recording unit 11 and AV encoding unit 15 as the projecting unit 18 is projecting the image 22 corresponding to the second video signal V2 onto the wall. The projecting device can stop operation of the sound-recording unit 11 and AV encoding unit 15 after the AV encoding unit 18 has output the AV synchronous play file so as to achieve the purpose of automatically starting or stopping the recording and AV encoding process. In the embodiment, the user can control the projecting device to actuate and stop sound recording and AV encoding operation.

When the user gives a brief by using the projecting device 10 and the electronic device 21, the user can use the projecting device 10 to project brief documents of the electronic device 21 onto the wall while recording his/her sound of explaining the brief documents. The projecting device 10 encodes synchronously the image projected onto the wall and the sound of explaining the brief documents into an AV synchronous play file according to a timing process. The audience can open the AV synchronous play file to regain the lively feeling as attending the user's brief in the future.

One who has general knowledge in the field of skills the embodiment belongs to will know that the skill of the invention is not limited thereto. For example, the AV encoding unit 15 can include a MPEG AV encoder, such as a MPEG 2/4 AV encoder. The storage unit 16 can include a memory or a hard disc, and the receiving unit 11 can include a universal serial bus (USB) receiving terminal or an IEEE 1394 output terminal. Moreover, the recording media 20 can include a mobile disk or a memory card, for instance, a stamp-size memory card such as a secure digital card, a multimedia card, a compact flash type I/II card, a smart media card, an IBM® Microdrive memory card, a Sony® memory stick, a Sony® memory stick-pro, and an xD memory card. The operation unit 19 can be a keyboard or a touch pad.

In the embodiment, images and sounds of the presenter as giving a brief are synchronously encoded into an AV synchronous play file so that the audience can open the AV synchronous play file to read the image content while listening to the sound corresponding to the image in the future. Therefore, the audience can quickly regain the lively feeling as attending the brief before and achieve the purpose of reviewing and revising the brief materials. It can be prevented not only the unfamiliar feeling occurred as reviewing the brief materials in the future but also the confusing issue due to inconsistency of the brief materials from beginning to end in the future review, thereby greatly increasing practicality of the projecting device.

### Embodiment Two

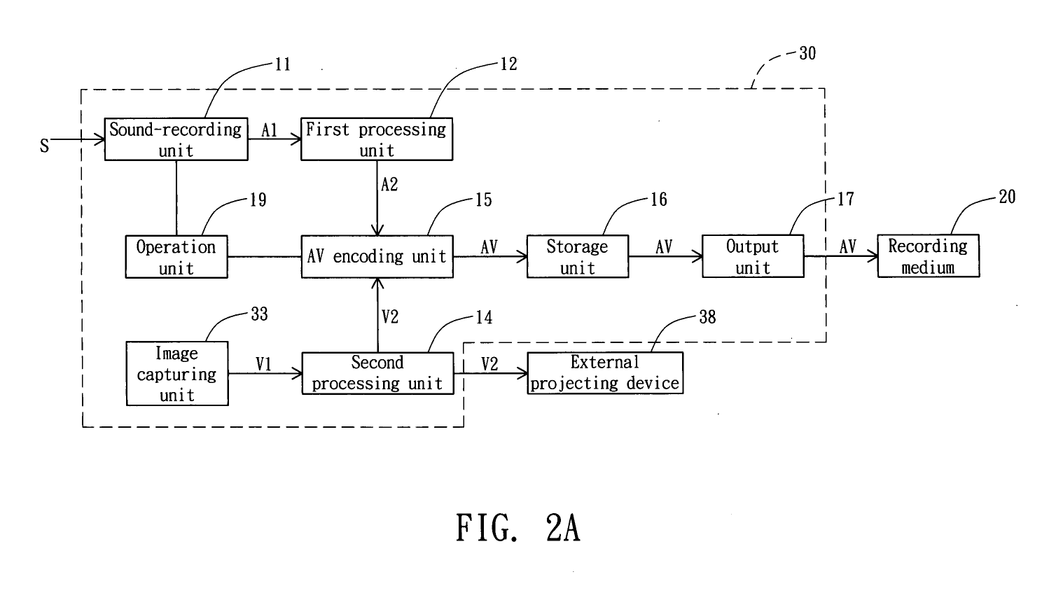

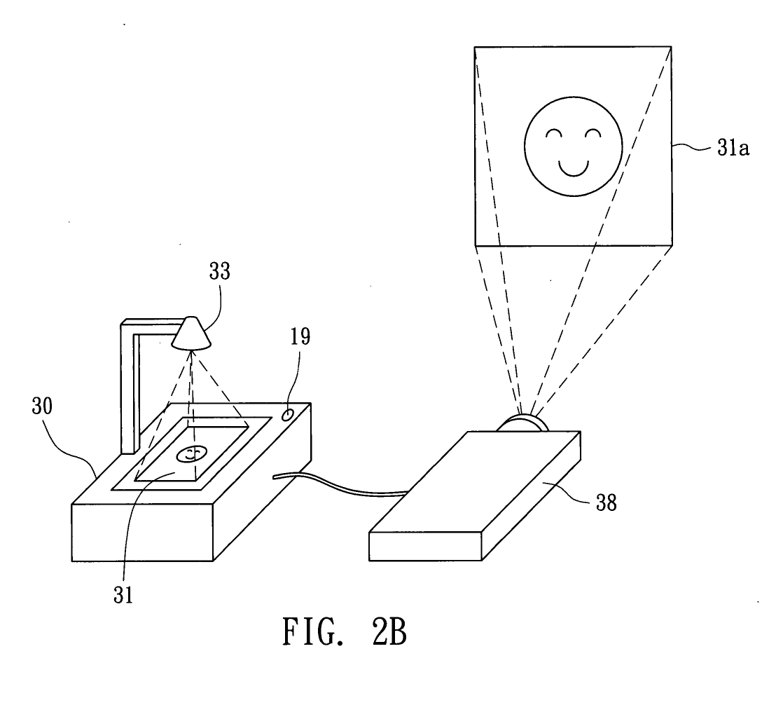

FIG. 2A shows a block diagram of a projecting device capable of synchronously encoding images and sounds into an AV synchronous play file, an external projecting device, and a recoriding medium according to the second embodiment of the invention while FIG. 2B shows a solid view of a projecting device capable of synchronously encoding images and sounds into an AV synchronous play file, an object, and an external projecting device according to the second embodiment of the invention. Referring to FIGS. 2A and 2B at the same time, the projecting device 30 of the embodiment includes an image capturing unit 30, but has no the projecting unit 18 and the receiving unit 13, which is different from the projecting device 10 in the first embodiment. The components of the projecting device 30, the same with those of the projecting device 10, are given the same labels as in the first embodiment and are not necessarily described in detail any more. In the embodiment, an object projector is taken as an example for the projecting device 30.

In FIGS. 2A and 2B, the image capturing unit 33 is for capturing the image of an object 31 and outputting a first video signal V1 accordingly. The first processing unit 14, electrically coupled to an external projecting device 38, is for receiving and processing the first video signal V1 and outputting a second video signal V2 to the external projecting device 38 accordingly, and the external projecting device 38 projects the image 31 a corresponding to the second video signal V2 onto a wall.

One who has general knowledge in the field of skills the embodiment belongs to will know that the skill of the invention is not limited thereto. For example, the projecting device 30 actuates the sound-recording unit 11 and the AV encoding unit 15 as the external projecting device 38 projects the image 31 a corresponding to the second video signal V2 onto the wall while the projecting device 30 stops operation of the sound-recording unit 11 and the AV encoding unit 15 after the AV encoding unit 11 outputs the AV synchronous play file AV. Moreover, the image capturing unit 33 includes a complementary metal-oxide semiconductor or a charge coupled device (CCD).

### Embodiment Three

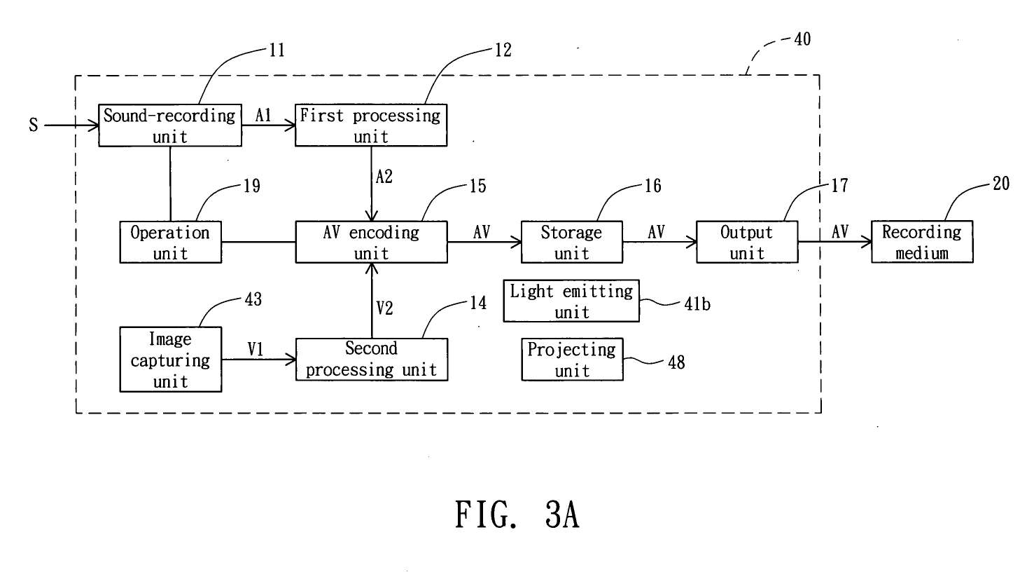

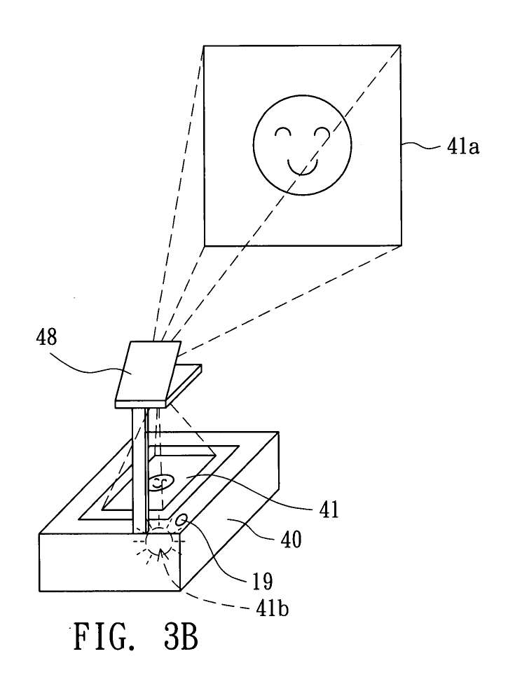

FIG. 3A shows a block diagram of a projecting device capable of synchronously encoding images and sounds into an AV synchronous play file according to the third embodiment of the invention while FIG. 3B shows a solid view of a projecting device capable of synchronously encoding images and sounds into an AV synchronous play file, and a projection film according to the third embodiment of the invention. Referring to FIGS. 3A and 3B at the same time, the projecting device 40 of the embodiment includes a light emitting unit 41b, a projecting unit 48, and an image capturing unit 43, but has no the receiving unit 13, which is different from the projecting device 10 in the first embodiment. The components of the projecting device 30, the same with those of the projecting device 10, are given the same labels as in the first embodiment and are not necessarily described in detail any more. In the embodiment, a film projector is taken as an example for the projecting device 40.

In FIGS. 3A and 3B, the projection film 41 is placed on the projecting flatbed of the projecting device 40. The light emitting unit 41b emits a beam of light to the projection film 41 while the projecting unit 48 magnifies and projects the light passing through the projection film 41 onto a wall to display an image 41a corresponding to the projection film content. The image capturing unit 43 captures the image 41a to output a first video signal V1. The first processing unit 14, electrically coupled to the image capturing unit 43, receives and processes the first video signal V1 to output a second video signal V2 to the AV encoding unit 15.

One who has general knowledge in the field of skills the embodiment belongs to will know that the skill of the invention is not limited thereto. For example, the image capturing unit 43 includes a complementary metal-oxide semiconductor or a charge coupled device (CCD). Moreover, the light emitting unit 41b can be a bulb, a lamp or a plane light source while the projecting unit 48 can be composed of an optics lens and mirrors.

By using the projecting device capable of synchronously encoding images and sounds into an AV synchronous play file according to the above-mentioned embodiments of the invention, images and sounds of the presenter as giving a brief are synchronously encoded into an AV synchronous play file so that the audience can open the AV synchronous play file to read the image content while listening to the sound corresponding to the image in the future. Therefore, the audience can quickly regain the lively feeling as attending the brief before and achieve the purpose of reviewing and revising the brief materials. It can be prevented not only the unfamiliar feeling occurred as reviewing the brief materials in the future but also the confusing issue due to inconsistency of the brief materials from beginning to end in the future review, thereby greatly increasing practicality of the projecting device.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A projecting device capable of synchronously encoding images and sounds into an audio/video (AV) play file, comprising:
a receiving unit, for receiving and outputting a first video signal;
a first processing unit, electrically coupled to the receiving unit, for receiving and processing the first video signal and outputting a second video signal accordingly;
a projecting unit, electrically coupled to the first processing unit, for receiving the second video signal and projecting an image corresponding to the second video signal onto a wall;
a sound-recording unit, for recording sounds of a user as explaining the image corresponding to the second video signal and outputting a first audio signal accordingly;
a second processing unit, electrically coupled to the sound-recording unit, for receiving and processing the first audio signal and outputting a second audio signal accordingly; and
an AV encoding unit, electrically coupled to the first processing unit and the second processing unit, for receiving and synchronously encoding the second video signal and the second audio signal and outputting an AV synchronous play file accordingly.

2. The projecting device according to claim 1, further comprising:
a storage unit, electrically coupled to the AV encoding unit, for receiving and storing the AV synchronous play file.

3. The projecting device according to claim 2, further comprising:
an output unit, electrically coupled to the storage unit, for outputting the AV synchronous play file to a recording medium.

4. The projecting device according to claim 1, further comprising:
an operation unit, electrically coupled to the sound-recording unit and the AV encoding unit, wherein the projecting device actuates the sound-recording unit and the AV encoding unit as the operation unit is pressed.

5. The projecting device according to claim 4, wherein when the operation unit is pressed once again, the projecting device stops the operation of the sound-recording unit and the AV encoding unit.

6. The projecting device according to claim 1, wherein the receiving unit is electrically coupled to an electronic device for receiving the first video signal output by the electronic device.

7. A projecting device capable of synchronously encoding images and sounds into an audio/video (AV) play file, comprising:
an image capturing unit, for capturing an image of an object and outputting a first video signal accordingly;
a first processing unit, electrically coupled to the image capturing unit and an external projecting device, for receiving and processing the first video signal and outputting at least a second video signal to the external projecting device by which an image corresponding to the second video signal can be projected onto a wall;
a sound-recording unit, for recording sounds of a user as explaining the image corresponding to the second video signal and outputting a first audio signal accordingly;
a second processing unit, electrically coupled to the sound-recording unit, for receiving and processing the first audio signal and outputting a second audio signal accordingly; and
an AV encoding unit, electrically coupled to the first processing unit and the second processing unit, for receiving and synchronously encoding the second video signal and the second audio signal and outputting an AV synchronous play file accordingly.

8. The projecting device according to claim 7, further comprising:
a storage unit, electrically coupled to the AV encoding unit for receiving and storing the AV synchronous play file.

9. The projecting device according to claim 8, further comprising:
an output unit, electrically coupled to the storage unit, for outputting the AV synchronous play file to a recording medium.

10. The projecting device according to claim 7, further comprising:
an operation unit, electrically coupled to the sound-recording unit and the AV encoding unit, wherein the projecting device actuates the sound-recording unit and the AV encoding unit as the operation unit is pressed.

11. The projecting device according to claim 10, wherein when the operation unit is pressed once again, the projecting device stops the operation of the sound-recording unit and the AV encoding unit.

12. A projecting device capable of synchronously encoding images and sounds into an audio/video (AV) play file, comprising:
a light emitting unit, for providing a beam of light to a projection film;
a projecting unit, for magnifying and projecting the light passing through the projection film onto a wall to display an image corresponding to content of the projection film;
an image capturing unit, for capturing the image and outputting a first video signal accordingly;
a first processing unit, electrically coupled to the image capturing unit, for receiving and processing the first video signal and outputting a second video signal accordingly;
a sound-recording unit, for recording sounds of a user as explaining an image corresponding to the second video signal and outputting a first audio signal accordingly;
a second processing unit, electrically coupled to the sound-recording unit, for receiving and processing the first audio signal and outputting a second audio signal accordingly; and
an AV encoding unit, electrically coupled to the first processing unit and the second processing unit, for receiving and synchronously encoding the second video signal and the second audio signal and outputting an AV synchronous play file accordingly.

13. The projecting device according to claim 12, further comprising:
a storage unit, electrically coupled to the AV encoding unit for receiving and storing the AV synchronous play file.

14. The projecting device according to claim 13, further comprising:
an output unit, electrically coupled to the storage unit, for outputting the AV synchronous play file to a recording medium.

15. The projecting device according to claim 12, further comprising:
an operation unit, electrically coupled to the sound-recording unit and the AV encoding unit, wherein the projecting device actuates the sound-recording unit and the AV encoding unit as the operation unit is pressed.

16. The projecting device according to claim 15, wherein when the operation unit is pressed once again, the projecting device stops the operation of the sound-recording unit and the AV encoding unit.
